(19) United States
(12) Patent Application Publication
(10) Pub. No.: US 2019/0075456 A1
(43) Pub. Date: Mar. 7, 2019

(54) SECURE WIRELESS PAIRING OF MASTER SLAVE DEVICES WITHQR CODES

(71) Applicant: BAE SYSTEMS Information and Electronic Systems Integration Inc., Nashua, NH (US)

(72) Inventors: Peter J. EVANS, Seabrook, NH (US); William P. McDONNELL, Stonington, ME (US)

(21) Appl. No.: 15/697,510

(22) Filed: Sep. 7, 2017

(51) Int. Cl. H04W 12/06; G06F 17/30; H04L 9/32; H04L 29/06

(52) U.S. Cl. CPC H04W 12/06; G06F 17/30879; H04W 76/023; H04L 63/0853; H04L 9/3263

(57) ABSTRACT

The system and method of wireless pairing using quick response (QR) codes containing encryption keys and pairing parameters. Detection of the pairing information by a wireless access device permits quick authentication and pairing between the wireless access device and a wireless sensor, or server, containing the QR code.

### FIELD OF THE DISCLOSURE

The present disclosure relates to secure wireless communication and more particularly to secure wireless paring of master slave devices with quick response (QR) codes.

### BACKGROUND OF THE DISCLOSURE

One conventional method of coordinating wireless servers with their clients is through a process commonly known as “pairing.” The effect of the pairing is that the client can select between multiple servers accessible simultaneously to the client, thereby being able to access the data of only preferred servers while ignoring the data of other servers. Likewise, it permits specific servers to receive commands only from paired clients while ignoring the commands of non-paired clients. Typically, the pairing process involves navigating menus that allow selection of servers, followed by the execution of the pairing protocol that establishes the communication scheme, e.g. one-to-one full duplex, one-to-one half duplex, one to many half duplex, etc. after which, the establishment of the link being accomplished, the client may make use of the service. It is often important to be able to pair quickly, while at the same time maintaining control over what level of service, if any, is provided to the client.

Wherefore it is an object of the present disclosure to overcome the above mentioned shortcomings and drawbacks associated with the conventional pairing mechanisms.

### SUMMARY OF THE DISCLOSURE

It has been recognized that vision systems provide a mechanism for simplification of the often complicated process for establishing connections between wireless clients and information servers. By combining encoded connection information visible to the user with vision processing capabilities clients can quickly exchange authorization and network parameters necessary to access application services.

One aspect of the present disclosure is a system comprising a digital camera with image processing capabilities, a tag with information about a service that can be used when compatible networking equipment has been properly set up to access the service, and the network service itself.

In one embodiment of the system a user scans the environment with a camera that processes the images of the environment to identify tags notifying the presence of a compatible service. Once identified, the user may then connect to the service through a simple gesture or button click. The details of the communication protocol and any necessary authorization credentials are provided through information encoded in the tag and potentially secured information residing on the user's camera system and the server. Once the pairing of the two devices has been established, the user can take advantage of any of the services authorized for use by that user.

Another aspect of the present disclosure is a secure wireless pairing system, comprising a wireless sensor comprising a first public key and a private key; a quick response code associated with the wireless sensor comprising pairing parameters and the first public key; and a wireless access device comprising a quick response code recognition program and a private key.

One embodiment of the secure wireless pairing system is wherein the wireless sensor is a server. Certain embodiments of the secure wireless pairing system are wherein the wireless sensor further comprises a camera. In some cases, the wireless access device comprises a camera. In certain cases, the wireless access device further comprises a display.

Yet another aspect of the present disclosure is a secure wireless pairing method, comprising providing a wireless sensor comprising a first public key, a private key, and data of interest; providing a quick response code associated with the wireless sensor comprising pairing parameters and the first public key; detecting the quick response code with a wireless access device having a quick response code recognition program; processing the quick response code to detect the first public key and the pairing parameters; comparing the first public key with a second public key from the wireless access device; passing information, if the first and the second public keys match, to a network awareness program; negotiating a pairing process between the wireless sensor and the wireless access device using the pairing parameters; and decoding the data of interest from the wireless sensor for use by the wireless access device.

One embodiment of the secure wireless pairing method is wherein the wireless sensor is a server. Certain embodiments of the secure wireless pairing system are wherein the wireless sensor further comprises a camera. In some cases, the wireless access device comprises a camera. In certain cases, the wireless access device further comprises a display.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular embodiments of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a diagram of one embodiment of the system of the present disclosure.

FIG. 2 shows a diagram of another embodiment of the system of the present disclosure.

FIG. 3 shows a flowchart of one embodiment of a method of the present disclosure.

### DETAILED DESCRIPTION OF THE DISCLOSURE

In many situations users need to be able to pair with a server very quickly. By using quick response (QR) codes, or other communication devices, the pairing can be achieved quickly. Quick response (QR) codes are two dimensional bar codes, or matrix barcodes. QR codes are a form of machine readable optical label that contains certain information about the item to which it is attached. Generally, QR codes use alphanumeric, numeric, binary, kanji, and other encoding modes to store data. A QR code is typically read by an imaging device, such as a camera, and the image is then processed so that the required data can be extracted from the patterns present in the horizontal and vertical components of the image.

The amount of data that can be stored in a QR code depends on the data type used and the error correction level. Generally, the higher the correction level, the less storage capacity for the QR code. In larger QR symbols, for example, the message may be broken up into several code blocks. There, the block size may be chosen so that at most a certain number of errors can be corrected in each block, thus limiting the complexity of the decoding algorithm. These code blocks may then be interleaved together, making it less likely that localized damage to a QR symbol will overwhelm the capacity of any single block.

In order to ensure that server data is delivered only to authorized clients, and that only authorized commands are executed, an encryption scheme is employed. The server and client use a scheme that allows a public key to be encoded in the QR code. Upon recognition of the QR code, the two systems, having appropriately compatible secret keys, would then be able to pair, and the client would gain the ability to decode the server data stream.

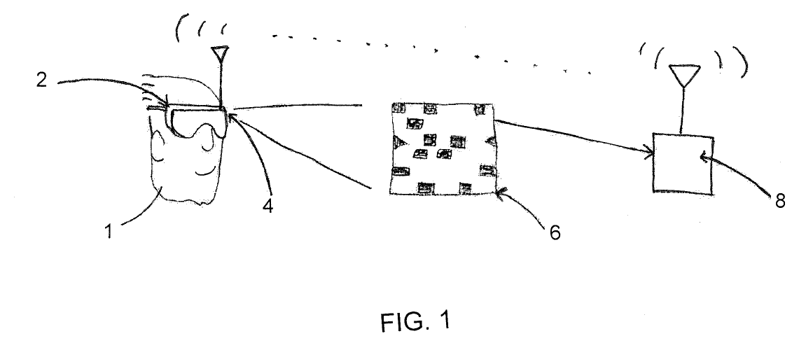

Referring to FIG. 1, a diagram of one embodiment of the system of the present disclosure is shown. More specifically, a user 1 has a wireless access device 4, such as a pair of goggles. The wireless device is configured to run a QR recognition program 2 remotely or on-board the wireless access device. The wireless access device 4 detects a QR code 6 within its field of view. The QR code is associated with a wireless sensor or server node 8.

In certain embodiments, QR codes are displayed on the housings of wirelessly enabled devices (can be a sticker or display such as e-ink or LCD), that contains the necessary pairing information. In some cases, that information includes information used to identify the network and securely connect the client to the network. When a user wearing a digital image sensor looks at the QR code, a software application decodes this information and instructs the user's wireless device to connect. In some cases, a public key is encrypted within the QR code to guarantee only users with proper access requirements can connect and access the device. Connecting to wireless devices by simply looking at them requires less time, fewer user inputs, and is more precise than traditional lists of network nodes.

Some embodiments of the present disclosure allow a user to pair securely to a wireless device with precision, requiring no user interface or input. In environments that contain a number of wireless systems (e.g., sensors, cameras, instruments etc.) a user could passively select their preferred network node without selecting through long complicated lists. Additionally, this technology provides seamless acquisition of data from sensors, cameras, and other devices simply by a user looking at the object of interest. This reduces the complexity of network pairing, mitigates user errors, and reduces the time it takes to connect.

In some cases, the system of the present disclosure can be used to enable a virtual reality experience. In one example, the virtual reality experience could be seeing “through” an armored vehicle's skin. An array of QR codes could both pair with the user's display and, by processing the location of the code or codes by the user's camera system, the displayed image could be mapped to track the user's head position to cue a corresponding viewing angle from the vehicle's situational awareness system feed. For example, tag ‘A’ is at camera pixel x1, y1, tag B is at camera pixel x2, y2, and the like. Therefore a user looking at azimuth P and elevation Q, could be mapped to a field-of-view pointer in the situational awareness system's 360 degree hemisphere that displays the view corresponding with the user's head orientation.

While video might be a preferred function for this system, it could be used to enable connection with any type of sensor. For example, a mechanic could pair with a QR tag that corresponds to a wireless enabled engine-hour meter or O₂ sensor, or the like, all without having to open the hood. A pilot could scroll through a set of QR codes on a tablet computer to check various sensors as part of a pre-flight check. A soldier could immediately pair any weapon sight with personal goggles. A corpsman could access soldier health data (e.g., heart rate, breathing, hydration, other emergency medical data), by scanning a QR code on a soldier's dog tag.

In certain embodiments, similar schemes could be conceived that use near-field communication tags, perhaps with directional antenna patterns, in place of the QR codes. This would be particularly useful for use with systems that do not or cannot have built-in cameras, or for systems where QR codes might be susceptible to obfuscation or present an undesirable probability of detection.

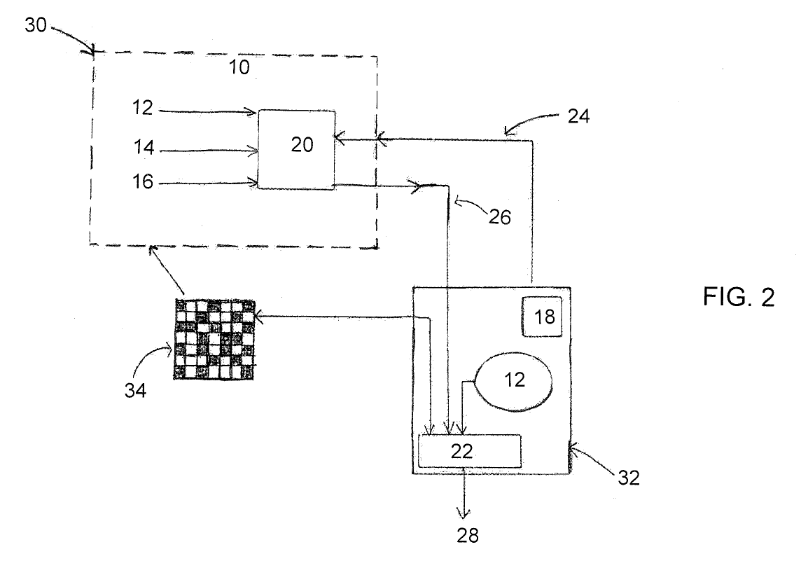

Referring to FIG. 2, a diagram of another embodiment of the system of the present disclosure is shown. More particularly, a QR code 34 contains a public key and pairing parameters. The QR code 34 is associated with a server 10 and is detected by a client 32. The server 10 comprises a private key 12, a public key 14, and data 16. The server has an encrypt/decrypt module 20 that receives network pairing parameter information 24 from the client 32 and sends out encrypted data 26, once paired with the client. The client 32 detects and reads the QR code 34 and comprises an encrypt module 18, a private key 12, and a decrypt module. In one embodiment of the system of the present disclosure, the server comprises a camera that is remotely located. In certain embodiments, the client is a display/camera combination. In some cases, the display client and remote camera have been pre-programmed with appropriate private keys, and the camera has knowledge of its public key. A QR code with an encoded public key and the camera pairing parameters is in the vicinity of the display/camera combination. The display combo and remote camera wireless communication link equipment are within the distance where operation is possible.

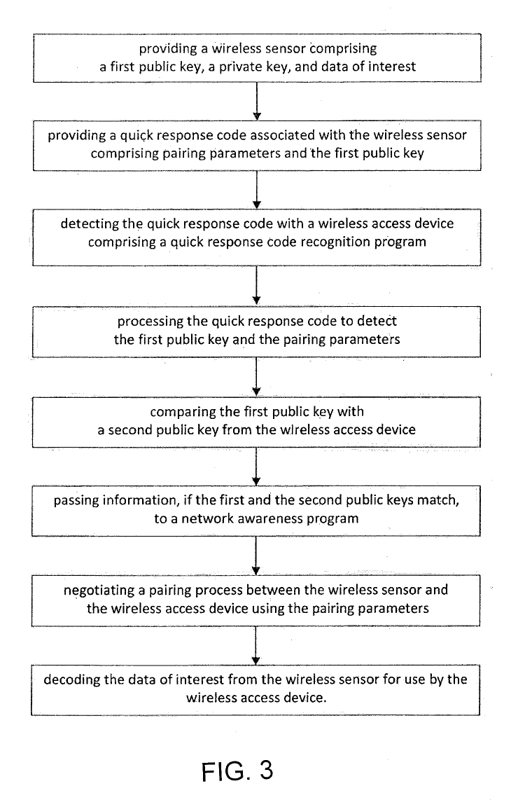

Referring to FIG. 3, in some cases the display/camera combo is running a QR recognition program. When a QR code is recognized, the program decodes the data, identifying a public key and network parameters. The QR recognition process hands off the information to a network awareness program. Using the private key and public key to decode messages from servers in the area, the recognition program is able to determine if a data stream is available. Once the data stream for the public key has been validated then the client and server can negotiate the pairing process. Once pairing is complete, the client can accept and use the server's data stream. For example, the display/camera combination could then display the video from the remote camera.

In certain embodiments, pairing parameters can include public-private keys for user authentication and link encryption, confirmations of authentication, profile information that prevents pairing of incompatible devices, media access control information such as a device's unique address, what communications channels a device may use, what bit rate will be used, and the like.

In some embodiments, the network awareness program provides the intelligence necessary to apply the information from the QR code to establish the existence of the server implied by the QR code. For example, a server may be offline, broken, or unable to accept new connections. The network awareness program establishes that the server associated with a given QR code is operational and ready to accept pairing requests.

In certain embodiments of the system of the present disclosure, the QR code recognition program scans an image from the user's camera system and correlates the image with its QR code archetype. In the event that the correlation between the scanned image and the archetype is sufficient, the recognition program extracts the bit values present in the scanned image. The bit values received are checked for errors, for example, by using a cyclic redundancy check (CRC) to ensure the integrity of the data. Depending on the QR code implementation, the program could apply forward error correction techniques to recover valid data from a noisy image. The data extracted from the QR code by the recognition program can then be used in the network awareness and pairing processes. In some embodiments, the QR code recognizer comprises a camera digital computer to process the data from the camera. In some cases, the network awareness program comprises a radio link compatible with the server. In certain cases, the user's hardware comprises a processor of sufficient capability to make use of the data provided by the server.

In another embodiment, a user wearing an augmented reality headset enabled to permit push notifications could automatically receive focused advertisements from a digital billboard or kiosk displaying a QR code that initiates a connection to a database of the user's preferences.

In yet another embodiment, a user wearing an augmented reality headset, upon recognition of a tag and authorization of payment, could be provided with a certain amount of time to access the magnified view of a scenic vista provided by a local telescope service.

The computer readable medium as described herein can be a data storage device, or unit such as a magnetic disk, magneto-optical disk, an optical disk, or a flash drive. Further, it will be appreciated that the term “memory” herein is intended to include various types of suitable data storage media, whether permanent or temporary, such as transitory electronic memories, non-transitory computer-readable medium and/or computer-writable medium.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device. The application program can be uploaded to, and executed by, a machine comprising any suitable architecture.

While various embodiments of the present invention have been described in detail, it is apparent that various modifications and alterations of those embodiments will occur to and be readily apparent to those skilled in the art. However, it is to be expressly understood that such modifications and alterations are within the scope and spirit of the present invention, as set forth in the appended claims. Further, the invention(s) described herein is capable of other embodiments and of being practiced or of being carried out in various other related ways. In addition, it is to be understood that the phraseology and terminology used herein is for the purpose of description and should not be regarded as limiting. The use of “including,” “comprising,” or “having,” and variations thereof herein, is meant to encompass the items listed thereafter and equivalents thereof as well as additional items while only the terms “consisting of” and “consisting only of” are to be construed in a limitative sense.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

A number of implementations have been described. Nevertheless, it will be understood that various modifications may be made without departing from the scope of the disclosure. Although operations are depicted in the drawings in a particular order, this should not be understood as requiring that such operations be performed in the particular order shown or in sequential order, or that all illustrated operations be performed, to achieve desirable results.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

1. A secure wireless pairing system, comprising:
a wirelessly enabled device comprising:
a first public key; and
a private key;
a first encrypt module;
a first decrypt module;
secure data of interest; and
a quick response code displayed on a housing of the wirelessly enabled device, the quick response code comprising pairing parameters for the wirelessly enabled device and the public key; and
a wireless access device comprising a pair of goggles configured to enable secure pairing without user input, comprising:
a quick response code recognition program;
a second encrypt module;
a second decrypt module; and
the private key.

2. The secure wireless pairing system of claim 1, wherein the wireless enabled device is a server.

3. The secure wireless pairing system of claim 2, wherein the wireless enabled device further comprises a camera.

4. The secure wireless pairing system of claim 1, wherein the wireless access device comprises a camera.

5. The secure wireless pairing system of claim 4, wherein the wireless access device further comprises a display.

6. A secure wireless pairing method, comprising:
providing a wireless enabled device comprising:
a public key;
a private key;
a first encrypt module;
a first decrypt module; and
data of interest;
providing a quick response code displayed on a housing of the wireless enabled device, the quick response code comprising pairing parameters for the wirelessly enabled device and the public key;
providing a wireless access device comprising a pair of goggles configured to enable secure pairing without user input, comprising:
a quick response code recognition program;
a second encrypt module;
a second decrypt module; and
the private key;
detecting the quick response code with the wireless access device;
processing the quick response code to detect the public key and the pairing parameters;
comparing the public key of the wireless enabled device with the public key from the wireless access device;
passing information, if the public keys match, to a network awareness program;
negotiating a pairing process between the wireless enabled device and the wireless access device using the pairing parameters; and
decoding the data of interest from the wireless enabled device for use by the wireless access device.

7. The secure wireless pairing method of claim 6, wherein the wireless enabled device is a server.

8. The secure wireless pairing method of claim 7, wherein the wireless enabled device further comprises a camera.

9. The secure wireless pairing method of claim 6, wherein the wireless access device comprises a camera.

10. The secure wireless pairing method of claim 9, wherein the wireless access device further comprises a display.

11. The secure wireless pairing system according to claim 1, wherein the pairing parameters are one or more of the following user authentication, link encryption, confirmation of authentication, profile information to prevent pairing of incompatible devices, media access control information such as a device's unique address, communications channels a device may use, and a bit rate to be used.

12. The secure wireless pairing method according to claim 6, wherein the pairing parameters are one or more of the following user authentication, link encryption, confirmation of authentication, profile information to prevent pairing of incompatible devices, media access control information such as a device's unique address, communications channels a device may use, and a bit rate to be used.

13. The secure wireless pairing system according to claim 1, wherein the wireless enabled device is associated with a vehicle and is used in maintenance of the vehicle.

14. The secure wireless pairing method according to claim 6, wherein the wireless enabled device is associated with a vehicle and is used in maintenance of the vehicle.

15. The secure wireless pairing system according to claim 1, wherein the wireless enabled device is associated with a person and is used in health monitoring.

16. The secure wireless pairing method according to claim 6, wherein the wireless enabled device is associated with a person and is used in health monitoring.

17. The secure wireless pairing system according to claim 1, wherein the quick response code is associated with a vehicle and is used for situational awareness.

18. The secure wireless pairing method according to claim 6, wherein the quick response code is associated with a vehicle and is used for situational awareness.

19. The secure wireless pairing system according to claim 3, wherein the camera provides a video stream to a display on the pair of goggles.

20. The secure wireless pairing method according to claim 8, wherein the camera provides a video stream to a display on the pair of goggles.
